(19) United States
(12) Patent Application Publication
(10) Pub. No.: US 2005/0021826 A1
(43) Pub. Date: Jan. 27, 2005

(54) Gateway controller for a multimodal system that provides inter-communication among different data and voice servers through various mobile devices, and interface for that controller

(76) Inventor: Sunil Kumar, San Diego, CA (US)

Correspondence Address: FISH & RICHARDSON, PC, 12390 EL CAMINO REAL, SAN DIEGO, CA, 92130-2081, US

(21) Appl. No.: 10/830,413

(22) Filed: Apr. 21, 2004

Related U.S. Application Data
(60) Provisional application No. 60/464,557, filed on Apr. 21, 2003.

(51) Int. Cl. G06F 15/16

(52) U.S. Cl. 709/232; 709/246

(57) ABSTRACT

A multimode system that allows communicating to different modes of servers, simultaneously. A special interface is used.

### CROSS-REFERENCE TO RELATED APPLICATIONS

This application claims priority under 35 U.S.C. 119(e)(1) to U.S. Provisional Patent Application No. 60/464,557, filed Apr. 21, 2003.

This application is also related to co-pending U.S. patent application Ser. No. 10/040,525, filed Dec. 28, 2001, entitled INFORMATION RETRIEVAL SYSTEM INCLUDING VOICE BROWSWER AND DATA CONVERSION SERVER, and to co-pending United States Provisional patent application Ser. No. 10/336,218, filed Jan. 3, 2003, entitled DATA CONVERSION SERVER FOR VOICE BROWSING SYSTEM, and to co-pending United States Provisional patent application Ser. No. 10/349,345, filed Jan. 22, 2003, entitled MULTI-MODAL INFORMATION DELIVERY.

### FIELD

The present description relates to method of intercommunication among different information gateways such as a messaging gateway (SMS, EMS, MMS), a WAP gateway (WML, XHTML etc), video gateway (packet video, real etc.), a voice gateway (e.g., VoiceXML, or MRCP), and rendering of information to various mobile devices in multiple forms such as, but not limited to, SMS, MMS, WML, XHTML, VoiceXML etc.

### BACKGROUND

The Internet has revolutionized the way people communicate. As is well known, the World Wide Web, or simply “the Web”, is comprised of a large and continuously growing number of accessible Web pages. In the Web environment, clients request Web pages from Web servers using the Hypertext Transfer Protocol (“HTTP”). HTTP is a protocol which provides users access to files including text, graphics, images, and sound using a standard page description language known as the Hypertext Markup Language (“HTML”). HTML provides document formatting and other document annotations that allow a developer to specify links to other servers in the network.

A Uniform Resource Locator (URL) defines the path to Web site hosted by a particular Web server. The pages of Web sites are typically accessed using an HTML-compatible browser (e.g., Netscape Navigator or Internet Explorer) executing on a client machine. The browser specifies a link to a Web server and particular Web page using a URL.

The information revolution has evolved from desktop to various handheld devices such as mobile phones, pocket PCs and PDAs. Earlier, the handheld devices used relatively primitive forms of messaging, such as short message service or SMS to send messages to other handheld devices. This worked well for sending small amount of information such as alerts, small pictures etc., but is not optimal for sending larger amounts of information.

In order to fetch content from the web, the handheld devices may use the proven WEB model. Standards such as WML, xHTML, iMODE, SMS/EMS/MMS allow content suitable of being viewed using the handheld devices. These devices use HTTP to access information using a URL as discussed above. With the limitation of having a small display screen and tedious input methods, existing handheld devices have met with consumer resistance with respect to accessing content over the web. A VoiceXML may be used for rendering content over a voice channel which uses voice as the primary mode of input and output. However, using voice as a mode of communication may cause the user to lose comprehension, if information of considerable size is provided to the user in voice form.

Multi-Modal standards such as SALT, IBM's X+V, and W3C Multimode have been designed specifically to provide interaction to content with combination of both voice and data. The Multi-Modal technology is expected to provide a way of accessing information in its most natural form. The user is not restricted to either using voice or using data. Multi-Modal technology allows user to choose the form of information depending on the context of the user.

This allows the handheld devices to be used with different information methods depending on the application. If the information to be sent is a small text message, a user can use SMS. Richer messages can be sent using EMS/MMS, that includes formatted text, video clips, animation etc. If the information resides on a server, browsers or Push technology can be used to fetch information from the server. The VoiceXML browsers can be used to access information in voice form, and Multi-Modal technology can be used to access information in combination of both voice and data form.

Devices that are installed with JAVA/BREW/Symbian can be used to render information in specific form not limited to standard SMS/MMS/PUSH/xHTML/WML form.

The above information methods for handheld devices require an information gateway to deliver the information in requested form. The messaging gateway (SMSC/MMSC) is used to send SMS/EMS/MMS. The video gateway such as from packet video/real is used to send streaming video. The WAP gateway is used to fetch information from the web in WML/xHTML form. The VoiceXML gateway delivers information in the form of dialogues and prompts. The MultiMode gateway controller or veGateway renders content based on the context of the user combining both data and voice.

However the above gateways restrict a handheld device to receive/send information using only one of the gateways at a particular instant. The usability would likely increase if a user could use multiple information gateways in a single session such as sending a SMS message using an SMS gateway while the user is in dialogue with the VoiceXML gateway.

### SUMMARY

The present application teaches a system and protocol, allowing multiple modes and communications to be carried out simultaneously.

### BRIEF DESCRIPTION OF THE DRAWINGS

FIG. 1 shows the gateway controller, and certain devices connected to the gateway controller;

FIG. 2 shows the connection between client, server and content;

FIG. 3 shows a flowchart of an information gathering;

FIG. 4 shows the gateway supporting two simultaneous sessions in different modes;

FIGS. 5-7 show exemplary screens obtaining information;

FIG. 8 shows a multimode controller with a session manager and resource manager;

FIG. 9A-9E show the operation of the controller.

### DETAILED DESCRIPTION

The present disclosure describes a Multimode Gateway Controller that enables a device to communicate with different information gateways simultaneously, in different modes while keeping the user session active, as a form of Inter-Gateway Communication. Each of the modes can be a communication mode supported by a mobile telephone, and can include, for example, voice mode, text mode, data mode, video mode, and the like. The Multimode Gateway Controller (MMGC) enables a device to communicate with other devices through different forms of information.

One form of multimedia gateway controller is the veGateway, and these terms are used herein to refer to the same structural components.

The MMGC provides a session using session initiation protocol, “SIP” to allow the user to interact with different information gateways one at a time or simultaneously, depending on the capability of the device. This provides an application that renders content in a variety of different forms including voice, text, formatted text, animation, video, WML/xHTML or others.

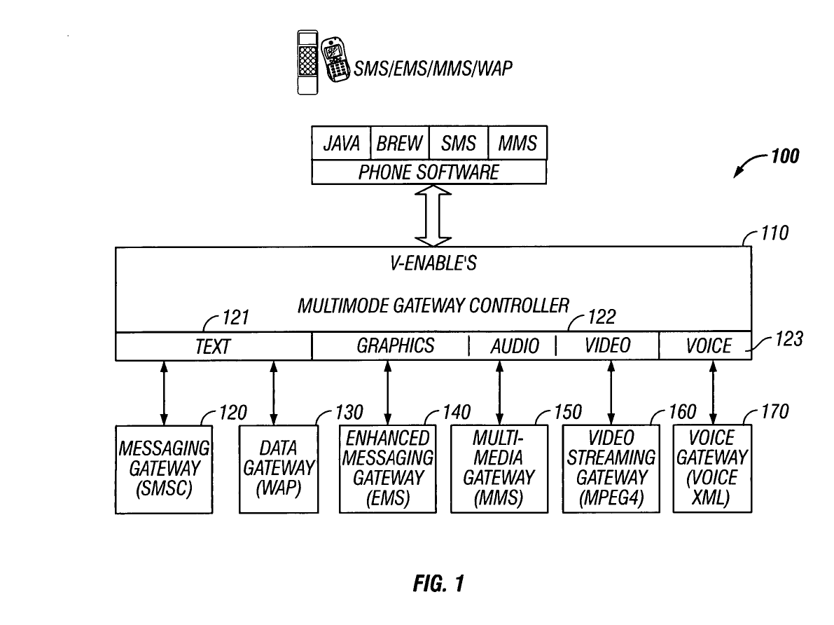

FIG. 1 shows a high level architecture of the MMGC, showing the interaction of the MMGC with different information gateways.

The Multimode Gateway may reside at the operator (carrier) infrastructure along with the other information gateways. This may reduce latency that is caused while interfacing with different gateways.

There are believed to be more than a billion existing phones which have messaging (SMS) and voice capability. All of those phones are capable of using the MMGC 110 of FIG. 1. Interacting with this gateway allows these phones to send an SMS message while in a voice session.

2G devices with SMS functionality can interface with the SMS gateway and the VoiceXML gateway. This means that basically all current phones can use the MMGC. The functionality proliferates as the installed base of phones move from lower end 2G devices to higher end 3G devices. The more highly featured devices allow the user to interface with more than just two gateways through MMGC.

FIG. 1 shows the Gateway controller 110 interfacing with a number of gateways including a messaging Gateway 120, a data Gateway 130, e.g. one which is optimized for WAP data, an enhanced messaging Gateway 140 for EMS communications, an MMS type multimedia Gateway 150, a video streaming Gateway 160 which may provide MPEG 4 type video, and a voice Gateway 170 which may operate in VoiceXML. Basically, the controller interfaces with the text gateways through text interface 121, that interfaces with the messaging Gateway 120 and the data Gateway 130. A multimedia interface 122 provides interface with the graphics, audio and video gateways. Finally, the voice interface 123 provides an interface with the voice Gateway.

In operation, a 3G device with simultaneous voice and data capability can receive a video stream through a Video gateway 160, such as Packet Video, while still executing a voice based application through a VoiceXML gateway 170 over the voice channel.

An interesting example could be a user searching for a movie using the voice channel. That user sees the video clip of the movie as part of the search result. In this example, the user interfaces with a voice gateway and video gateway. In another useful example demonstrating the capability of the MMGC, a user searches for latest movie running in a nearby theatre using the voice channel which uses an interface 170 with a VoiceXML Server.

After finding the movie of interest, the user receives the details of the movie on the mobile phone screen using an interface 130 with a WAP gateway. The disclosed MMGC helps in initiating a data session while a user is in a voice session.

The user wants to forward the details of the movie/theatre to his friends.

The user sends the details as SMS messages to a friend whose phone device only supports SMS using the interface 120 with the SMS gateway.

The user sends the details as formatted text, along with a picture of the movie and a small animation of the movie to his friend whose phone device has support for EMS/MMS using an interface 144 with EMS/MMS gateway.

The user sends the details as formatted text along with a streaming video clip of the movie to his friend whose phone device has capability to receive streaming video using an interface with video gateway 170.

The above example demonstrates how an application can interface with different information gateway through the MMGC, depending on the capability of the device.

The veANYWAY solution can be used on variety of device types ranging from SMS only devices, to advanced devices with the Java/Brew/Symbian/Windows CE etc. platform. This veANYWAY solution moves from a server only solution to a distributed solution as the devices move from SMS only devices to more intelligent devices with Java/Brew/Symbian/Windows CE capability. With intelligent devices, a part of application can be processed at the client itself, thus increasing the usability and reducing the time involved in bringing everything from the network.

The veANYWAY solution communicates with the various information gateways using either a Distributed approach or a Server only approach.

In the distributed approach, the veCLIENT and veGATEWAY form two components of the overall solution. With an intelligent device, the veCLIENT becomes the client part of the veANYWAY solution and provides a software development kit (SDK) to the application developer which allows the device to make use of special functionality provided by the veGATEWAY server.

In the case of browser only devices where no software can be downloaded, the browser itself acts as the client and is configured to communicate with the veGATEWAY 100. The veGATEWAY 110 on the server side provides an interface between client and the server. A special interface and protocol between veCLIENT and the veGATEWAY is known as the Vodka interface.

If the veCLIENT can be installed on the mobile device, it allows greater flexibility and also reduces the traffic between client and server. The veCLIENT includes a multimodal SDK which allows developers to create multimodal applications using standards such as X+V, SALT, W3C multimode etc and also communicates with the veGATEWAY 112 at the server. The communication with the veGATEWAY is done using XML tags that can be embedded inside the communication. The veCLIENT processes the XML tags and makes appropriate communication with the veGATEWAY. In case of a browser only client, these XML tags can either be processed by the veCLIENT or by the veGATEWAY server. The veCLIENT component also exports high-level programming APIs (java/BREW/Symbian/Windows CE etc.) which can be used by the application developers to interact with the veGATEWAY (instead of using XML based markup) and use the services provided by veGATEWAY.

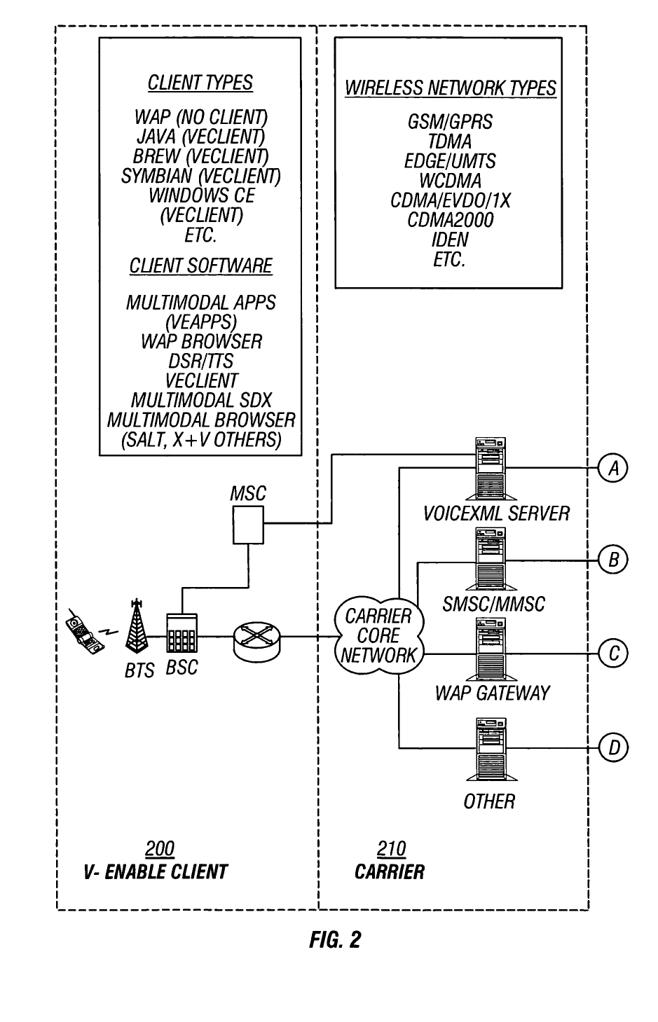

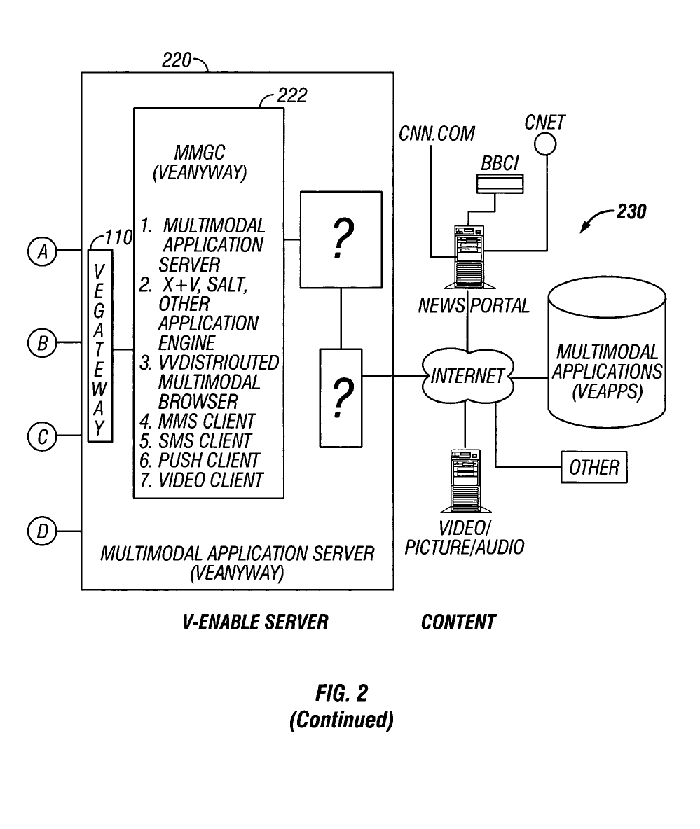

FIG. 2 shows the architecture of the veANYWAY solution in a carrier environment. The structure in FIG. 2 has four main components.

First, the V-Enable Client (veCLIENT) 200 is formed of various sub-clients as shown. The clients can be dumb clients such as SMS only or Browser Only clients (WAP, iMode etc.) or can be intelligent clients with installed Java, Brew, Symbian, Windows platforms that allow adding software on the device. In case of dumb clients, the entire processing is done at the server and only the content is rendered to the client.

In case of an intelligent client, a veCLIENT module is installed on the client, which provides few APIs for application developers. This also has a multimodal browser that can process various multimodal markups in the communication (X+V, SALT, W3C Multimodal 1) in conjunction with the multimodal server (veGATEWAY). The veCLIENT also provides the XML tags to the applications, to communicate with the information Gateways special veAPPS form the applications which can use the veCLIENT functionality.

The Carrier Network 210 component forms the communication infrastructure needed to support the veANYWAY solution. The veANYWAY solution is network agnostic and can be implemented on any type of carrier network e.g., GSM, GPRS, CDMA, UTMS etc.

The V-Enable Server 220 includes the veGATEWAY shown in FIG. 1. It provides interfaces with other information gateways. The veGATEWAY also includes a server side Multimodal Browser which can process the markups such as SALT, X+V, W3C multimodal etc. It also processes the V-enable markups, which allows a browser only client to communicate with certain information gateways such as SMS, MMS, WAP, VoiceXML etc in the same session. For intelligent thin clients, the V-Enable markup is processed at the client side by the veCLIENT.

The server (veGATEWAY) also includes clients 222, which may include a MMS Client, SMS Client, and WAP Push Client which is required in order to process the request coming from the devices. These clients connect with the appropriate gateways via the veGATEWAY, sequentially or simultaneously, to deliver the information to the mobile device.

The content component 230 includes the various different forms of content that may be used by the veANYWAY solution for rendering. The content in multimodal form can include news, stocks, videos, games etc.

The communication between the veCLIENT and veGATEWAY uses a special interface, called the Vodka interface, which provides the necessary infrastructure needed for a user to run a Multimodal application. The Vodka interface allows application to access appropriate server resources simultaneously, such as speech, messaging, video, and any other needed resources.

The veGATEWAY provides a platform through which a user can communicate with different information gateways as defined by the application developer. The veGATEWAY provides necessary interfaces for the inter-gateway communication. However, these interfaces must be used by an application efficiently, to render content to the user in different forms. The veGATEWAY interfaces can be used with XML standards such as VoiceXML, WML, xHTML, X+V, and SALT. The interfaces provided by veGATEWAY are processed in a way so that they take the form of the underlying native XML markup language. This facilitates the application production by the developer, without worrying about the language they are using. The veGATEWAY interprets the underlying XML language and processes it accordingly.

In an embodiment, the interfaces are in the form of XML tags which can be easily embedded into the underlying XML language such as VoiceXML, WML, XHTML, SALT, X+V. The tags instruct the veGATEWAY on how to communicate with the respective information gateway and maintain the user session while across the different gateways. The XML tags can be replaced by the API interface for a conventional application developer who uses high-level languages for developing applications. The conventional API interface is especially useful in case of intelligent clients, where applications are partially processed by the veCLIENT. The application developers can use either XML tags or APIs, without changing the functionality of the veGATEWAY.

The further discussion describes on XML markup tags as the interface being used, understanding that the concept can be ported to an API based interface, without changing the semantics.

The communication with different information gateways may require the user to switch modes from data to voice or from voice to data, based on the capability of the device. Devices with simultaneous voice and data capability may not have to perform that switching mode. However, devices incapable of simultaneous voice and data may switch in order to communicate with the different gateways. While this switch is made, the veGATEWAY maintains the session of the user.

A data session is defined as when a user communicates with the content. The communication can use text/video/pictures/keypad or any other user interface. This could be either done using the browsers on the phone or using custom applications developed using JAVA/BREW/SYMBIAN. The data can SMS, EMS, MMS, PUSH, XHTML, WML or others.

Using WAP browsers to browse web information is another form of a data session. Running any network-based application on a phone for data transaction is also a form of a data session. A voice session is one where the user communicates using speech/voice prompts as the medium for input and output. Speech processing may be done at the local device or on the network side. The data session and voice session can be active at the same time or can be active one at a time. In both cases, the synchronization of data and voice information is done by the server veGATEWAY at the server end.

The following XML tags can be used with any of the XML languages.

Note: The names of the tags used herein are exemplary, and it should be understood that the names of the XML tags could be changed without changing their semantics.

<switch>

<switch> tag while executing a voice based application such as VoiceXML is used to initiate a data session while the user is interacting in a voice session. The initiation of a data session may result in termination of a currently active voice session if the device does not support simultaneous voice and data session. Where the device supports simultaneous voice and data, the veGATEWAY opens a synchronization channel between the client and the server for synchronization of the active voice and data channel. The <switch> XML tag directs the veGATEWAY to initiate a data session; and upon successful completion of data initiation, the veGATEWAY directs the data session to pull up a visual page. The visual page source is provided as an attribute to the <switch> tag. The data session could be sending WML/xHTML content, MMS content, EMS message or an SMS message based on the capability of the device and the attributes set by the user.

The execution of the <switch> may just result in plain text information to be sent to the client and allow the veCLIENT to interpret the information. The client/server can agree on a protocol for information exchange in this case.

One of the examples for sending plain text information would include filling in fields in a form using voice. The voice session recognizes the input provided by the user using speech and then sends the recognized values to the user using the data session to display the values in the form.

The <switch> tag can also be used to initiate a voice session while in a visual session. The initiation of the voice session may result in the termination of a currently active visual session if the device does not support simultaneous voice and data session. In case of a device supporting simultaneous voice and data, the veGATEWAY opens up a synchronization channel between the client and the server for synchronization of the active voice and data channel. The <switch> XML tag directs the veGATEWAY to initiate a voice session, and upon successful completion of voice initiation, the veGATEWAY directs the voice session to pull up a voice page.

The voice source may be used as an attribute to the <switch> tag. The voice session can be started with a regular voice channel provided by the carrier or could be a voice channel over the data service provided by the carrier using SIP/VoIP protocols.

The <switch> tag may have a mandatory attribute URL. The URL can be:
1. VoiceXML source
2. WML source
3. XHTML source
4. other XML source

The MMGC converts the URL into an appropriate form that can be executed using a VoiceXML server. This is further discussed in our co-pending application entitled DATA CONVERSION SERVER FOR VOICE BROWSING SYSTEM, U.S. patent application Ser. No. 10/336,218, filed Jan. 3, 2003.

Whether the user switches from data to voice or voice to data, the veGATEWAY adds capability in a specified content so that the user can return to the original mode.

The <switch> interface maintains the session while a user toggles between the voice and data session. The <switch> results in a simultaneously active voice and data session if the device provides the capability.

Besides sending plain text information, the data or voice session can carry an encapsulated object. The object can represent the state of the user in current session, or any attributes that a session wishes to share with other sessions. The object can be passed as an attribute to the <switch> tag.

<switch> syntax:

<switch url=WML|xHTML|VoiceXML|Text|X+V|SALT object=OBJECT Source/>

Whether the user is in a data session or in a voice session, the user can use the following interfaces to send information to the user in different forms through the veGATEWAY. Of course, this can be extended to use additional XML based tags, or programming based APIs.

<sendsms>

The <sendsms> tag is used to send an SMS message to the current user or any other user. Sending SMS to the current user may be very useful in certain circumstances, e.g., while the user in a voice session and wants to receive the information as a SMS. For example, a directory assistance service could provide the telephone number as an SMS rather than as voice.

The <sendsms> tag directs the MMGC to send an SMS message. The <sendsms> takes the mobile identification number (MIN) and the SMS content as its input, and sends an SMS message to that MIN. The veGATEWAY identifies the carrier of the user based on the MIN and communicates appropriately with the corresponding SMPP server for sending the SMS.

The SMS allows the user to see the desired information in text form. In addition to sending an SMS, the veGATEWAY adds a voice interface, presumably a PSTN telephone number, in the SMS message. The SMS phones have the capability to identify a phone number in a SMS and to initiate a phone call. The phone call is received by the veGATEWAY and the user can resume/restart its voice session e.g. the user receives an SMS indicating receipt of a new email, and the user dials the telephone number in the SMS message, to listen to all the news emails in voice form.

<sendems>

The <sendems> tag is used to send an EMS message to the current user or to any other user. Sending EMS to the current user is useful when a user is in a voice session and wants to receive the information as an EMS e.g. in a directory assistance service. The user may wish to receive the address as an SMS rather than listening to the address. The XML tag directs the MMGC to send an EMS message. The <sendems> takes the mobile identification number and EMS content as input and sends an SMS message to that MIN. The veGATEWAY also identifies the carrier of the user and communicates appropriately with the corresponding SMPP server. The EMS allows user to see the information in text form.

As above, the veGATEWAY may also add a voice interface, e.g., a telephone number in the EMS message. The EMS phones have capability to identify a phone number in an EMS and initiate a phone call. The phone call is received by the veGATEWAY and the user can resume/restart its voice session e.g. the user receives an EMS indicating receipt of a new email and the user dials the telephone number in the EMS message automatically to listen to the news emails in voice.

<sendmms>

<sendmms> tag is used to send an MMS message to the current user or to any other user. The XML tag directs the veGATEWAY to send an MMS message. The <sendmms> takes the mobile identification number and MMS content as input and sends an MMS message to that MIN. As above, the veGATEWAY based on the MIN identifies the carrier of the user and communicates appropriately with the corresponding MMS server. The MMS allows the user to see information in text/graphics/video form. In addition to sending an MMS, the veGATEWAY adds a voice interface e.g., a telephone number, in the MMS message. The MMS phones have capability to identify a phone number in a MMS and to initiate a phone call. The phone call is received by the veGATEWAY and the user can resume/restart its voice session e.g. the user receives an MMS indicating he received a new email and user dials the telephone number in the MMS message automatically to listen to the news emails in voice.

<sendpush>

The <sendpush> tag is used to send a push message to the current user or to any other user. The XML tag directs the veGATEWAY to send a push message. The <sendpush> takes the mobile identification number and URL of the content as the input to it and sends a push message to the user identified by the MIN. The veGATEWAY gateway identifies the carrier of the user and communicates appropriately with the corresponding push server.

The veGATEWAY identifies the network of the user, e.g., 2G, 2.5G or 3G and delivers the push message by communicating with the corresponding network in an appropriate way. The WAP push allows the user to see the information in text/graphics form. Besides sending a WAP PUSH, the veGATEWAY adds a voice interface, e.g., a telephone number in the PUSH content message. The WAP phones have capability to initiate a phone call while in a data session. The phone call is received by the veGATEWAY and allows user to resume/restart its voice session.

<sendvoice>

The <sendvoice> tag is used to send voice content (e.g., in VoiceXML form) to the current user or to any other user. This XML tag directs the veGATEWAY to initiate a voice session and to execute specified voice content. This tag is especially useful for sending voice based notifications. The voice session can be either initiated by either using the PSTN calls or using SIP based calls.

The tags <sendsms><sendems><sendmms><sendpush><sendvoice> can be used to send information to the other users or current user while a user is in a multimodal session. Each of these tags adds a voice interface or data interface in the content that they send. The voice interface enables to start a voice session while user is in a data mode and vice-versa.

The above mentioned XML markup tags for intercommunication are either processed at the client by veClient software or are processed by veGATEWAY server at the server end based on the client capability.

### EXAMPLE

The following examples illustrate the use of <switch>, <sendpush>, <sendsms>, <sendems>, <sendmms> in one single application. For demonstration purpose the XML languages used are VoiceXML and WML. However any other markup languages could be used as mentioned above. The example consists of few VoiceXML source and WML source. Few source markups are generated dynamically based on the user input.

moviefinder.vxml
<vxml>

<form id=“test”>

<field id=“city_name”>

<grammar

src=“http://veAnyway/appl/grammar/city.grammar”/>

<prompt> Please say the name of the city that you are

looking for </prompt>

<filled>

<prompt>you said <value

expr=“city_name”/></prompt>

</filled>

</field>
<field id=“movie_name”>

<grammar

src=“http://veAnyway/appl/grammar/movie.grammar”/>

<prompt> Please say the name of the movie you are

looking for.</prompt>

<filled>

<prompt>you said <value

expr=“movie_name”/></prompt>

<goto

next=“http://veAnyway/appl/theaterfinder.jsp”/>

</filled>

</field>

</form>

<vxml>
results.vxml
<vxml>

<form id=“test”>

<field id=“search_results”>

<prompt>Your search matches four theaters in nearby

area. Pleas say “show me list” to see them on your mobile screen

</prompt>
<grammar>

show me list | show {show}

</grammar>
<filled>

<prompt>You will see the list of theaters

running “Two Weeks Notice” in your area in a moment</prompt>

<switch

url=“http://veAnyway/appl/theaterresults.jsp”/>

</filled>

</field>

</form>

</vxml>
displayresults.wml
<?xml version=“1.0”?>
<!DOCTYPE wml PUBLIC “-//WAPFORUM//DTD WML 1.1//EN”
“http://www.wapforum.org/DTD/wml_1.1.xml”>
<wml>

<card title=“movie theaters”>

<p mode=“nowrap”>

<big>Search Results</big>
<select name=“item”>

<option

onpick=“http://veAnyway/appl/theater.jsp?movie=Two Weeks
Notice &amp;theater=East Gate Mall, La Jolla, California”>East Gate
Mall, La Jolla, CA</option>

<option

onpick=“http://veAnyway/appl/theater.jsp?movie= Two Weeks Notice
&amp;theater=Mission Valley, San Diego, California”>Mission Valley,
San Diego, CA</option>

<option

onpick=“http://veAnyway/appl/theater.jsp?movie= Two Weeks Notice
&amp;theater=Fashion Valley, San Diego, California”>Fashion Valley,
San Diego, CA</option>

</select>

</p>

</card>

</wml>
twoweeksnoticetimings.wml
<?xml version=“1.0”?>
<!DOCTYPE wml PUBLIC “-//WAPFORUM//DTD WML 1.1//EN”
“http://www.wapforum.org/DTD/wml_1.1.xml”>
<wml>

<card title=“movie_theaters”>

<do type=“accept” label=“Desc”>

<go href=“signsdescription.wml”/>

</do>
<do type=“options” label=“Buy”>

<go href=“buyticket.wml”/>

</do>
<p mode=“nowrap”>

<big>Show times</big>

3.20 PM, 4.50 PM, 7.45 PM, 10.00 PM

</p>

</card>

</wml>
twoweeksnoticedescription.wml
<?xml version=“1.0”?>
<!DOCTYPE wml PUBLIC “-//WAPFORUM//DTD WML 1.1//EN”
“http://www.wapforum.org/DTD/wml_1.1.xml”>
<wml>

<card title=“Description”>

<do type=“options” label=“SendTo”>

<go href=“send.wml”/>

</do>
<p>

<big>Two weeks notice:</big>
Starring: Sandra Bullock, Hugh Grant, Lainie

Bernhardt, Dorian Missick, Mike Piazza. <br/>

Synopsis: Millionaire George Wade doesn't make a move

without Lucy Kelson,

his multi-tasking Chief Counsel at the Wade

Corporation.

A brilliant attorney with a strategic mind, she also

has an ulcer and doesn't get much sleep.

It's not the job that's getting to her--it's George.

Smart, charming and undeniably self-absorbed,

he treats her more like a nanny than a Harvard-

trained lawyer--and can barely choose a tie without her help.

Now, after five years of calling the shots, on

everything from his clothes to his divorce settlements,

Lucy Kelson is calling it quits. Although George

makes it difficult for Lucy to leave the Wade Corporation,

he finally agrees to let her go--but only if she

finds her own replacement. After a challenging search,

she hires an ambitious young lawyer with an obvious

eye on her wealthy new boss.

Finally free of George and his 24-hour requests, Lucy

is ready to change course and join her devoted boyfriend

on an adventure at sea. Or is she? Confronted with

the fact that Lucy is literally sailing out of his life,

George faces a decision of his own: is it ever too

late to say I love you?

</p>

</card>

</wml>
sendinfo.wml
<?xml version=“1.0”?>
<!DOCTYPE wml PUBLIC “-//WAPFORUM//DTD WML 1.1//EN”
“http://www.wapforum.org/DTD/wml_1.1.xml”>
<wml>

<card title=“Description”>

<do type=“options” label=“SMS”>

<sendsms src=“Description” destination=“address”>

</do>
<do type=“options” label=“EMS”>

<sendems src=“EMS Source” destination=“address”>

</do>
<do type=“options” label=“MMS”>

<sendmms src=“MMS Source” destination=“address”>

</do>
<do type=“options” label=“Push”>

<sendpush src=“Push URL” destination=“address”>

</do>
<p mode=“nowrap”>

<big>Send info as:</big>

</p>

</card>

</wml>

The application is network and mobile phone agnostic and can run on devices of different types.

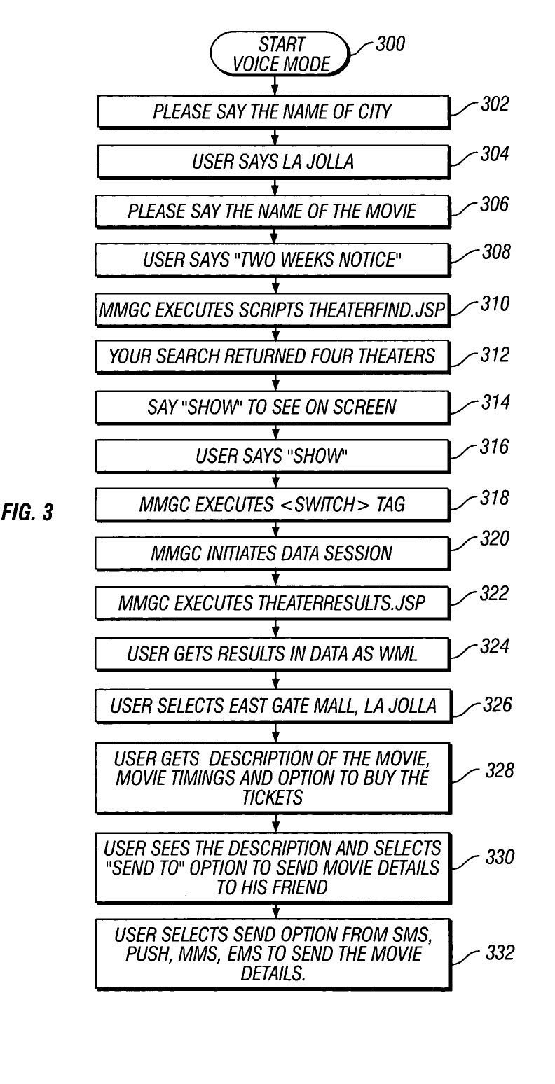

The operation proceeds according to the flowchart of FIG. 3.

The application starts in voice mode when the user dials into a VoiceXML compliant server at 300. The dialing could either be a PSTN call or VoIP call using SIP/RTP. The VoiceXML server executes the VoiceXML source moviefinder.vxml described above.

At 302, the VoiceXML server prompts the user to speak the name of the city where it wants to locate the movie theater running the movie. The user says La Jolla, Calif. at 304. 306 prompts for the name of the movie and at 308, the user says “Two weeks notice”.

The VoiceXML server looks for nearby theaters at 310 by executing the theater finding script, and brings up a list of movie theaters in La Jolla, Calif. currently running movie “Two weeks notice”.

The VoiceXML server prompts user with the list of theaters in the chosen area at 312.

The user is prompted at 314, to say “show me” and the user says it at 316. Here, the <switch> tag is used, switching from voice to data at 318).

At this point, veGATEWAY server initiates a data session at 320 and closes the currently active voice session.

The data session is initiated on the user's mobile device.

The browser on the mobile device pulls up the visual page containing the list of movie theaters at 322.

The user can now see the list (324) and can pick the closest movie theater at 326.

The user also finds a small description of the movie and buy options. If the users device is capable of MMS than the user can also see a small video clip of the movie.

The user can buy tickets for himself and for his friends. The user now wants to send the movie theaters details and movie information to his friends.

The users gets the option to either send using SMS, EMS, MMS, Push depending on the capability of the recipients device. The user just says “send this information to” (following users) and specifies the content at 330.

The veGATEWAY queries the device capability of recipients and sends information accordingly at 332.

The veGATEWAY not only provides the inter-gateway communication but also carries out state management when a user interfaces from one gateway to another gateway. The synchronization is provided wherever needed. The state manager is important, especially when the user switch from one mode to another and the device is not capable of providing simultaneous data and voice. The synchronization is needed between the voice session and data session if the device is capable of simultaneous modality and both the channels are active at the same time.

In case of simultaneous modality, any changes in the voice session may need to update corresponding changes in data. For example, when the user speaks the word “Boston”, the voice session recognizes it and the synchronization subsystem communicates Boston to the data session. The data session may display Boston on the mobile screen.

When the user changes mode from either data to voice, or from voice to data, the state manager components maintains the necessary information that may be lost because of the mode switching. The synchronization is provided when needed.

The veGATEWAY uses the XML tags for communicating with other information gateways. The XML tags are processed by the veGATEWAY and converted into low-level software routines that conform to underlying software such as Java/C/JSP etc. When the user switches from one gateway to another gateway, the veGATEWAY maintains the session of the user.

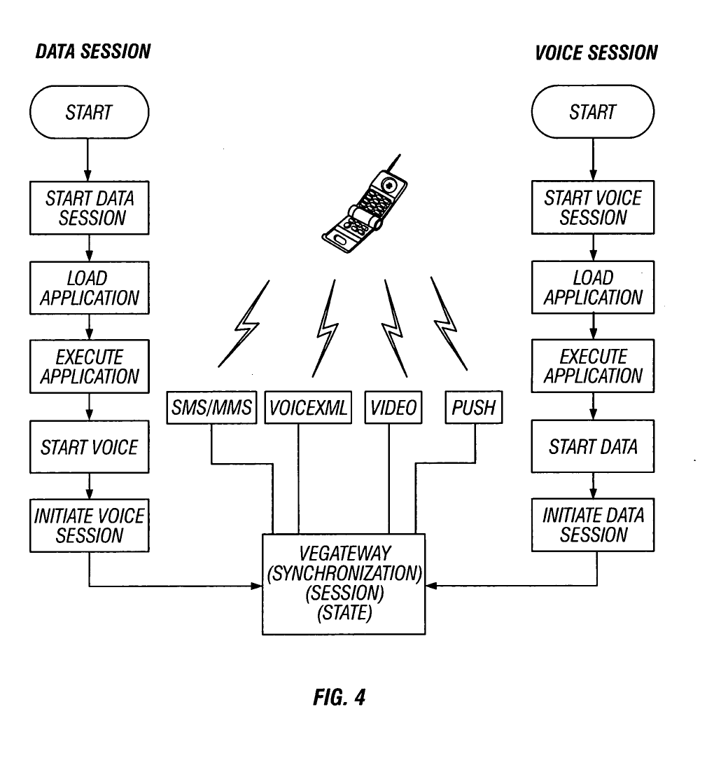

FIG. 4 shows how the Gateway 110 carries out the processing. This is described in further detail with reference to an example given herein. Basically, in this embodiment, the Gateway carries out synchronization, session operations, and state operations.

The user uses the WAP browser in the mobile device to connect to the veGATEWAY.

The MMGC fetches the application moviefinder.vxml, which may be written in VXML. It processes any V-Enable specific XML tags in the code, applies multi-coding and converts the VXML source into MultiMode VoiceXML as described in our application entitled: MULTI-MODAL INFORMATION DELIVERY SYSTEM, U.S. patent application Ser. No. 10/349,345, filed Jan. 22, 2003.

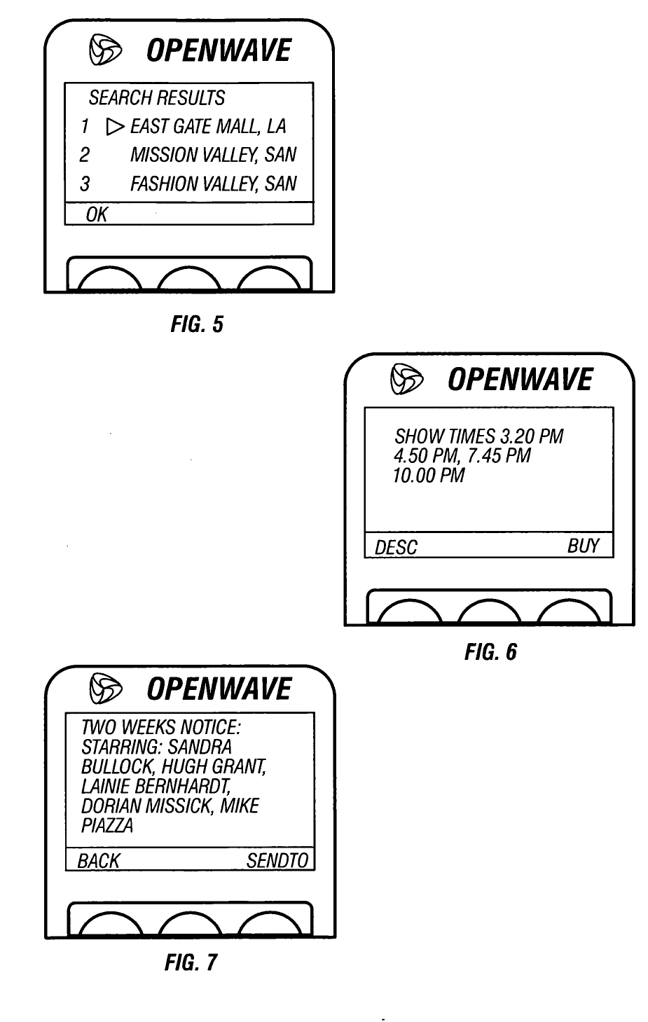

The generated VoiceXML is passed to a VoiceXML compliant server for execution. The VoiceXML server prompts the user to input the name of the city and the name of the movie. Upon receiving the city and movie name from the user, the VoiceXML server executes the theaterfinder.script. The theaterfinder.script uses the name of the movie and city name for the search and returns the search results in form of a VoiceXML results.vxml. The execution of results.vxml prompts the user to say “show” to see the search result on the screen, rather than listening to all the results in voice. The user says “show” to see the results on the screen. At this point, the veGATEWAY initiates a data session and pushes the visual content through the WAP gateway. Based on the application design, the veGATEWAY can make the connection with VoiceXML server or it can keep the connection. In this application scenario, the connection with the VoiceXML is terminated and a data session is started.
displayresults.wml is used to start the data session. Once the data session is started, the user is redirected to veGATEWAY. The veGATEWAY detects that user wishes to view displayresults.wml (State management). FIG. 5 shows the exemplary display result. At this point, the veGATEWAY fetches the displayresults.wml and processes it for any specific tags, converts them into appropriate native form and provides an additional voice interface and renders it back to the user.

The user selects the first option from displayresults.wml, which requests veGATEWAY to execute a script theater.jsp that searches for the details of the movie “Two weeks notice” in the La Jolla area.

The output of the script execution is another WML which displays timing information. The file twoweeksnoticetimings.wml presents the show timings, provides option of buying tickets and an option to see a full description about the movie. FIG. 6 shows an exemplary output from the script, showing the movie show times, and the options.

The user selects “description” causing the veGATEWAY to render twoweeksnoticedescription.wml. This visual source provides following information about the movie:
1. Movie Summary
2. A Video Clip
3. An Audio Clip
4. A Movie Picture

This information may be displayed based on the device capability. A WAP browser phone without video capability will only be able to access following information about the movie
1) story summary
2) movie picture
3) audio clip over voice channel.

FIG. 7 shows the returned description. The user also gets the option to send the information about the movie by selecting the “Send” button.

The sending can be based on the capability of the device that the recipient(s) are used. The information is sent as SMS, EMS, MMS, WML, or Voice using V-Enable XML tags <sendsms><sendems><sendmms><sendpush><sendvoice> respectively.

The above example description describes a fairly simple application scenario using XML markup languages as the source of the application, and using existing standard browser (WAP and VoiceXML) technologies for execution. The concept of inter-gateway communication can easily be implemented to support other applications written using high level languages such as Java/Brew/C/C++ etc and running proprietary systems.

The VODKA interface enables the communication between the veCLIENT and veGATEWAY and provides necessary infrastructure to run a multimodal simultaneous application on a thin client.

### Vodka Interface Detailed Description

As mentioned above, an intelligent device (e.g., a Brew/Symbian/J2me enabled handset) has two components of the veGATEWAY multimodal solution (Distributed approach), the veCLIENT and the veGATEWAY. The veGATEWAY, server part of the solution, provides a platform using which allows the user/client to communicate with different information gateways as defined by the application developer. The veCLIENT forms the client part of the solution, and has the multimodal SDK that can be used by the application developer to use the functionality provided by the veGATEWAY server, to develop multimodal applications.
veGATEWAY uses resource adapters/interfaces to communicate with various information gateways on behalf of the user/client to efficiently render content to the user/client in different form. The interface between the veCLIENT and veGATEWAY is called the Vodka interface. This is based on the standard SIP and RTP protocols.

The SIP (Session Initiation Protocol) component of the Vodka interface is used for user session management. The RTP (Real-time Transport Protocol) component is used for transporting data with real-time characteristics, such as interactive audio, video or text.

The client opens a data channel with the veGATEWAY and uses the SIP/RTP based Vodka interface to request the veGATEWAY to communicate with one or more information gateways on its behalf. Both the voice and data packets, if required by the application, can be multiplexed over the same channel using RTP avoiding the need for a separate voice channel.

The Vodka SIP interface supports standard SIP methods such as REGISTER, INVITE, ACK and BYE on a reliable transport media such as TCP/IP channel. The REGISTER method is used to by the user/client to register with the veGATEWAY server (veGateway). The veGATEWAY server does some basic user authentication at the time of registration to validate the user credentials. After registering with the veGATEWAY server, the user/client may initiate one or more sessions to communicate with one or more information gateways as required by the user application.

The INVITE method is used by the client to initiate a new session with the veGATEWAY server to communicate with any one of the information gateways as required by the user application. The information gateway is to be used for a session is specified using SDP (Session Description Protocol), in the form “a=X-resource_type:<VOICE|MMSC|SMSC|WAP| . . . >” and “a=X-resource_name:<name>: param_name1=param_value1; param_name2=param_value2; . . . ” in the INVITE method body. The ACK method is used by the client to acknowledge the session setup procedure. The BYE method is used to terminate an established session.

For example if user application/client needs to access two information gateways after registering with the veGATEWAY server, the user application would initiate two sessions using the SIP INVITE method.

The Vodka RTP interface supports a new multimodal RTP profile on a reliable transport medium such as TCP/IP channel. The RTP multimodal profile defines a new payload type and set of events namely VE_REGISTER_CLIENT, VE_CLIENT_REGISTERED, VE_PLAY_PROMPT, VE_PROMPT_PLAYED, VE_RECORD, VE_RECORDED, VE_GET_RESULT and VE_RESULT. These events are used by the user application/client with in a session to request the veGATEWAY server to communicate with the information gateway defined for this particular session, during session establishment procedure using SIP INVITE method, to play voice prompts or get voice recognition results or text search results or the like.

Table 1 specifies the payload definition for the new multimodal RTP profile in the Vodka RTP interface:

TABLE 1

| Field Name | Size | Description |
|---|---|---|
| Event | 7 bits | These events define actions |
| | | for the client or the |
| | | veGATEWAY Server that |
| | | indicate how to process data |
| | | accompanying this event. |
| | | List of valid events are: |
| | | 1. VE_REGISTER_CLIENT |
| | | 2. VE_CLIENT_REGISTERED |
| | | 3. VE_PLAY_PROMPT |
| | | 4. VE_PROMPT_PLAYED |
| | | 5. VE_RECORD |
| | | 6. VE_RECORDED |
| | | 7. VE_GET-RESULT |
| | | 8. VE_RESULT |
| | | 9. VE_CHANNEL_RESET |
| End bit (E) | 1 bit | This field is used to |
| | | indicate the end of an |
| | | event. |
| | | Valid list of values are: |
| | | 0 - More data expected for |
| | | event |
| | | 1 - Last event and no more |
| | | data is expected. |
| Event Length | 16 bits | This field is number of |
| | | octets of data that are |
| | | contained in this payload |
| | | for a specific event. |
| Event Data | variable length octet | This field has the event |
| | | specific data like a media |
| | | file or recorded buffers or |
| | | a text message. |

Table 2 specifies the event data details for various events defined in the RTP multimodal profile:

TABLE 2

| Event | Event Data Format | Description |
|---|---|---|
| VE_REGISTER_CLIENT | Event (7 bit): | This event is used by the |
| | VE_REGISTER_CLIENT | client to register an RTP |
| | End Bit (1 bit): 1 (true)/ | session with the |
| | 0 (false) | veGATEWAY server. The |
| | Event length (16 bit): | server uses this event to |
| | <variable length> | correlate a RTP session |
| | Event Data: | to a SIP session. |
| | Binding Info (variable | |
| | length): should be the same | |
| | as what was specified in SIP | |
| | REGSITER request. | |
| VE_CLIENT_REGISTERED | Event (7 bit): | This event is used by |
| | VE_CLIENT_REGISTERED | veGATEWAY server to |
| | End Bit (1 bit): 1 (true)/ | indicate status of RTP |
| | 0 (false) | registration request. |
| | Event length (16 bit): | |
| | <variable length> | |
| | Event Data: | |
| | Status (8 bits): 0 (success)/ | |
| | non zero (failure) | |
| | Error Code (8 bits): reason | |
| | for failure | |
| VE_PLAY_PROMPT | Event (7 bit): | This event is used by the |
| | VE_PLAY_PROMPT | client to request the |
| | End Bit (1 bit): 1 (true)/ | veGATEWAY Server to play |
| | 0 (false) | a voice prompt. The |
| | Event length (16 bit): | prompt could be played |
| | <variable length> | locally by the veGATEWAY |
| | Event Data: | server or the veGATEWAY |
| | Local Prompt (1 bit): 0 | server would request the |
| | (false)/1 (true) | appropriate information |
| | | gateway (eg. Vxml |
| | | server) reserved for the |
| | | session to play the voice |
| | | prompt |
| VE_PROMPT_PLAYED | Event (7 bits): | This event is used by the |
| | VE_PROMPT_PLAYED | veGATEWAY server to |
| | End Bit (1 bit): 1 (true)/ | indicate the success or |
| | 0 (false) | failure of a previously |
| | Event length (16 bit): | requested VE_PLAY_PROMPT |
| | <variable length> | event. Incase the call |
| | Event Data: | was successful media |
| | Status (8 bits): 0 (success)/ | format, media text and |
| | non zero (failure) | the media stream are sent |
| | Error (8 bits): failure | to the client to be |
| | reason. present only if | played. The media stream |
| | PLAY_PROMPT event was | to be played could be |
| | successful | sent in one or more than |
| | Media Format (8 bits): If | one RTP packet. |
| | event PLAY_PROMPT was | |
| | successful, this field | |
| | identifies format of the | |
| | media stream (mulog, gsm | |
| | etc) | |
| | Media Text length (16 bits): | |
| | present only if event | |
| | PLAY_PROMPT was successful. | |
| | Media Text: <variable | |
| | length> present only if | |
| | PLAY_PROMPT event was | |
| | successful. | |
| | Media Stream length (16 | |
| | bits): present only if | |
| | PLAY_PROMPT event was | |
| | successful | |
| | Media Stream (variable | |
| | length): present only if | |
| | PLAY_PROMPT event was | |
| | successful. | |
| VE_RECORD | Event (7 bits): VE_RECORD | This event is used by the |
| | End Bit (1 bit): 1 (true)/ | client to request the |
| | 0 (false) | veGATEWAY server to start |
| | Event length (16 bit): | recording the media |
| | <variable length> | stream that is to be used |
| | Event Data: | for voice recognition by |
| | Media Format (8 bits): This | the information gateway. |
| | field identifies format of | The recorded media stream |
| | the recorded media stream | could be sent in one or |
| | (mulog, gsm etc) sent by the | more than one RTP |
| | client. | packets. |
| | Media Stream (variable | |
| | length): This field has the | |
| | recorded media stream as | |
| | sent by the client. | |
| VE_RECORDED | Event (7 bits): VE_RECORDED | This event is used by the |
| | End Bit (1 bit): 1 (true)/ | VeGATEWAY server to |
| | 0 (false) | indicate the success or |
| | Event length (16 bit): | failure of a previously |
| | <variable length> | requested VE_RECORD |
| | Event Data: | event. |
| | Status (8 bits): 0 (success)/ | |
| | non zero (failure) | |
| | Error (8 bits): failure | |
| | reason. Present only if | |
| | VE_RECORD event failed. | |
| VE_GET_RESULT | Event (7 bits): | This event is used by the |
| | VE_GET_RESULT | client to request the |
| | End Bit (1 bit): 1 (true)/ | veGATEWAY server to send |
| | 0 (false) | the search results for |
| | Event length (16 bit): | the voice recognition |
| | <variable length> | done as requested in the |
| | Event Data: | VE_RECORD event. It also |
| | Start Index (8 bits): 0..n − 1 | has the start index and |
| | (where n = 100) | candidate count that is |
| | Candidate Count (8 bits): | the maximum number of |
| | 0..n (where n = 100) This | search results to be sent |
| | indicates the number of | to the client. |
| | candidates to be fetched | |
| | starting from the start | |
| | index | |
| VE_RESULT | Event (7 bits): VE_RESULT | This event is used by the |
| | End Bit (1 bit): 1 (true)/ | veGATEWAY server to |
| | 0 (false) | return the search result |
| | Event length (16 bit): | to the client. |
| | <variable length> | |
| | Event Data: | |
| | Status (8 bits): 0 (success)/ | |
| | non zero (failure) | |
| | Error (8 bits): failure | |
| | reason. Present only if | |
| | VE_GET_RESULT event failed. | |
| | Candidate Count (8 bits): | |
| | 0..n (where n = 100) present | |
| | only if VE_GET_RESULT event | |
| | was successful. Indicates | |
| | the candidate count in the | |
| | search list. | |
| | Total Candidate Count (8 | |
| | bits): 0..n (where n = 100) | |
| | present only if | |
| | VE_GET_RESULT event was | |
| | successful. Indicates the | |
| | total number of candidates | |
| | retrieved from the | |
| | information gateway for a | |
| | particular voice recognition | |
| | query. | |
| | Search Result (variable | |
| | length): colon delimited | |
| | string of results | |
| VE_CHANNEL_RESET | Event (7 bits): | This event is used by the |
| | VE_CHANNEL_RESET | veGATEWAY server to |
| | End Bit (1 bit): 1 (true)/ | notify that the RTP data |
| | 0 (false) | channel with veGATEWAY |
| | Event length (16 bit): | server has been closed. |
| | <variable length> | |
| | Event Data: | |
| | reason (8 bits): reason for | |
| | closing the RTP data | |
| | channel. | |

The veCLIENT multimodal SDK includes generic API's such as Register, RecognizeSpeechInput, RecognizeTextInput, GetRecognitionResult, SendSMS, SendMMS etc. Each of these generic multimodal SDK API's internally initiate one or more SIP/RTP messages defined in the Vodka interface to interact with the appropriate information Gateway and achieve the desired functionality. For example, the RecognizeSpeechInput API internally initiates a new SIP session with the veGATEWAY server using the SIP INVITE method and reserves an available Voice information gateway for the session. Then, the recorded user speech is sent to the veGATEWAY server for recognition by the voice information gateway. The voice recognition results are retrieved using another API, here, the GetRecognitionResult, of the multimodal SDK.

All the Vodka interface details related to the SIP/SDP and RTP protocols is hidden from the client by the multimodal SDK provided in the veCLIENT part of the veANYWAY multimodal solution. The application developer needs to use the generic multimodal SDK API's to build a multimodal application. The SDK handles all the Vodka interface specific parsing and formatting of SIP/RTP messages.

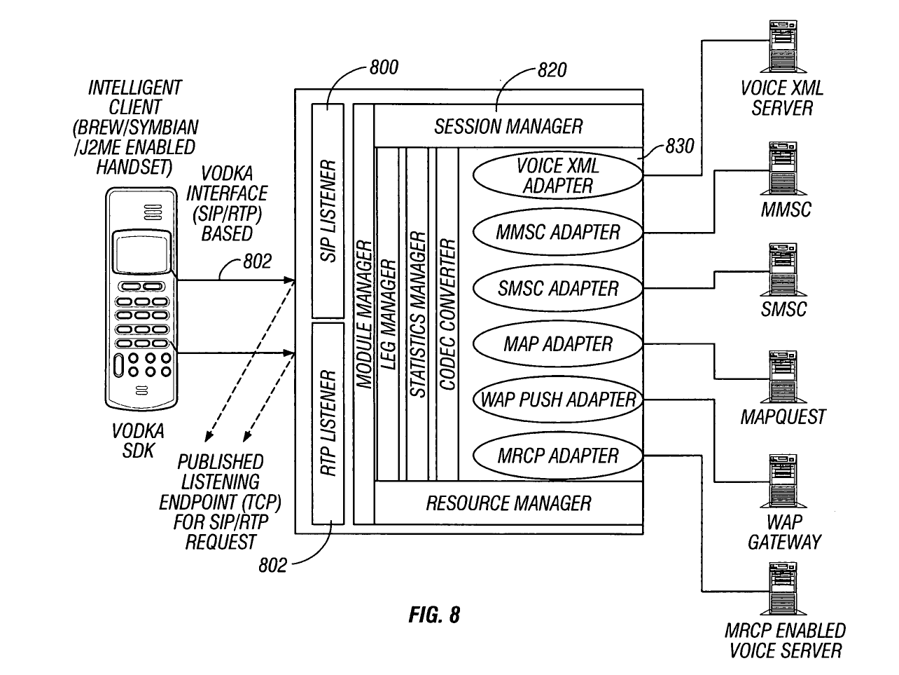

A high level architecture and brief description of various modules of veGATEWAY server with respect to the Vodka interface is shown in FIG. 8.

The listener is formed of an SIP listener 800, and an RTP listener 802. These listen for new TCP/IP connection requests from the client on published SIP/RTP ports, and also poll existing TCP channels (both SIP/RTP) for any new requests from the client.

The module manager 810 provides the basic framework for the veGATEWAY server. It manages startup, shutdown of all the modules and all inter module communication.

A session manager 820 and resource manager 822 maintains the session for each registered client. They also maintain a mapping of which information gateway has been reserved for the session and the valid TCP/IP connections for this session. Based on this information, requests are routed to and from the appropriate information gateway specific adapters. Parsing and formatting of SIP/RTP/SDP messages is also done by this module.

One or more information gateway specific adapters/interfaces 830 are configured in the veGATEWAY server. These adapters abstract the implementation specific details of interaction with a specific information gateway e.g., the VoiceXML server, ASR server, TTS server, MRCP server, MMSC, SMSC, WAP gateway from the client. The adapters translate generic requests from the client to information gateway specific requests, thereby allowing the client to interact with any information gateway using the predefined Vodka interface.

A message flow of a sample “Directory Assistance multimodal Application (DA application)” is described. DA application has been built using the veCLIENT multimodal SDK. DA application allows users to search, find, and locate business listings. It is multimodal in the sense that the user can choose to speak or type the input on his/her mobile device and receive output from the application using both voice and the visual display. The message flow specified below assumes the use of Voice information gateway provided by Phonetics systems. The concept however is independent of a gateway provider and can work with different vendors.

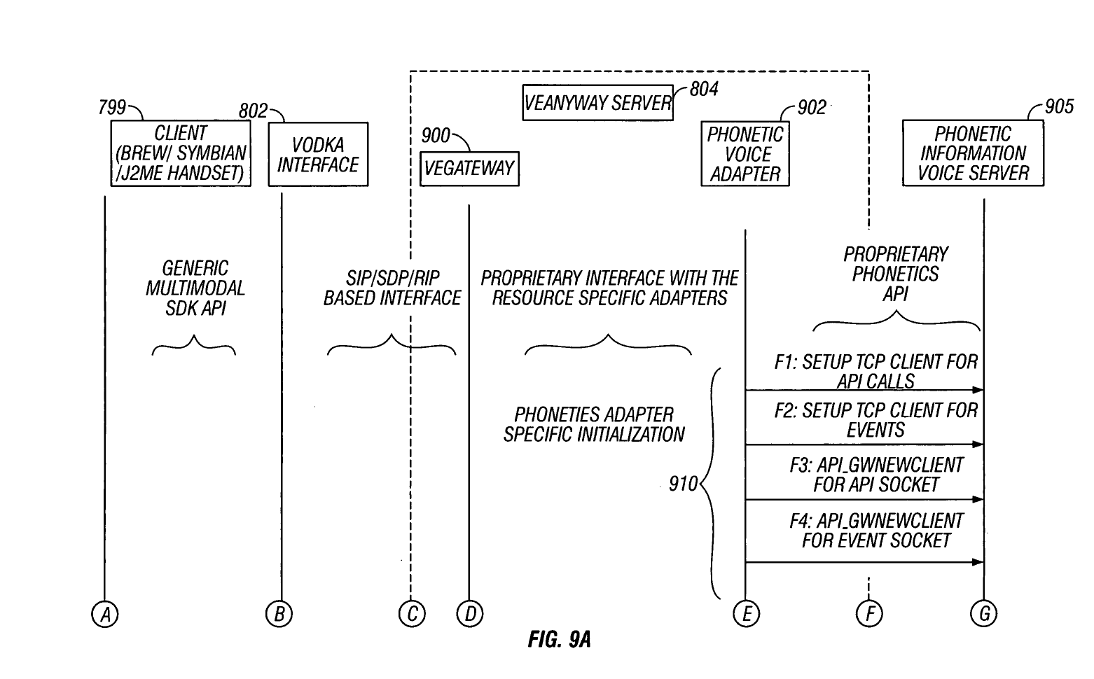

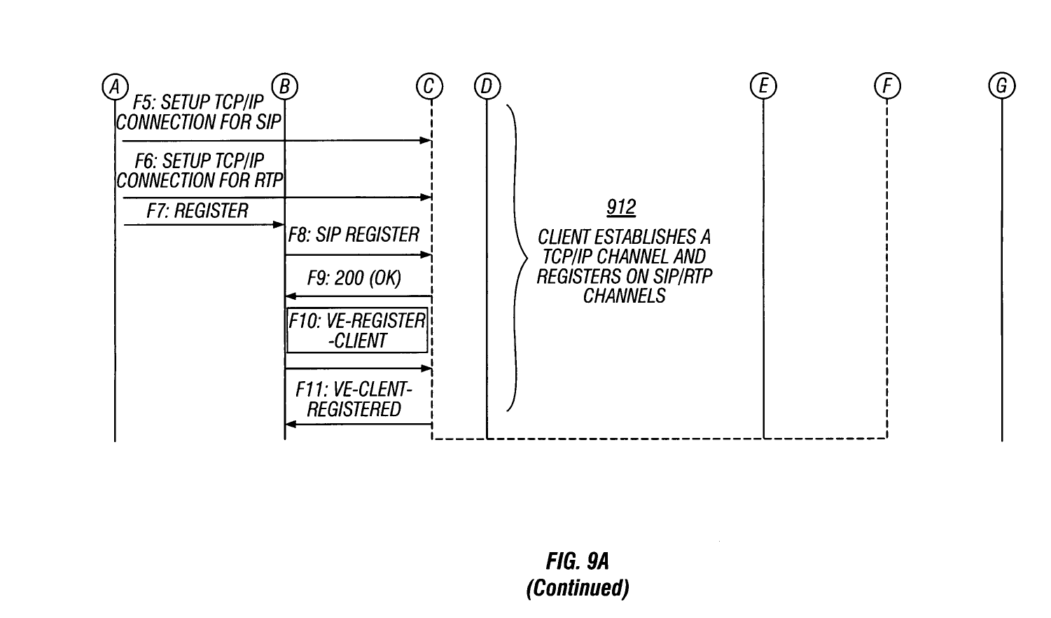

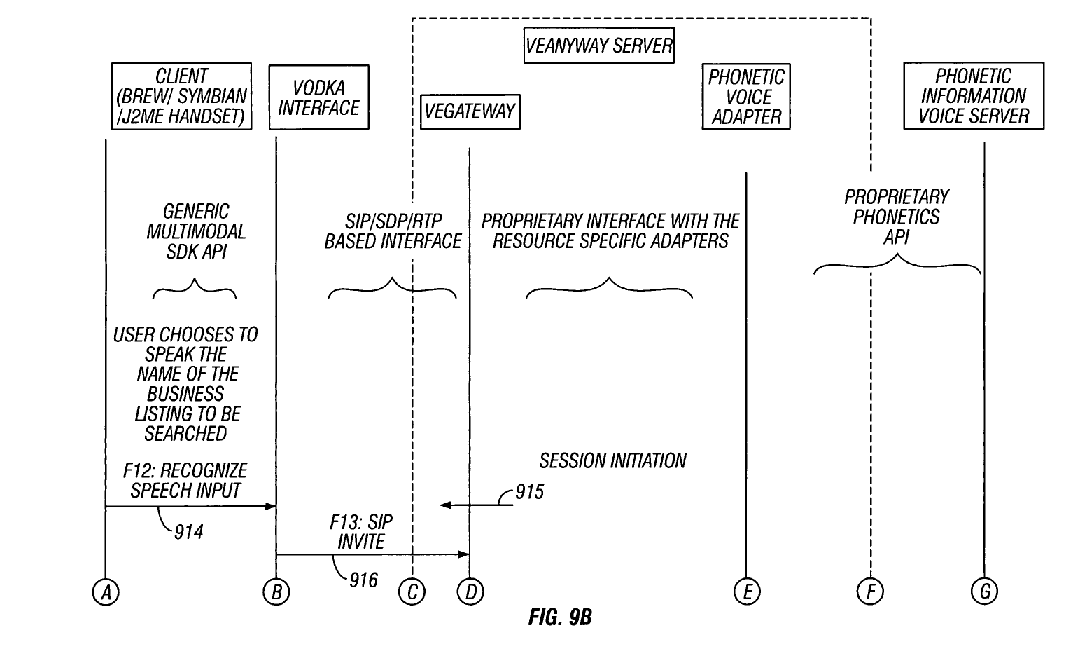

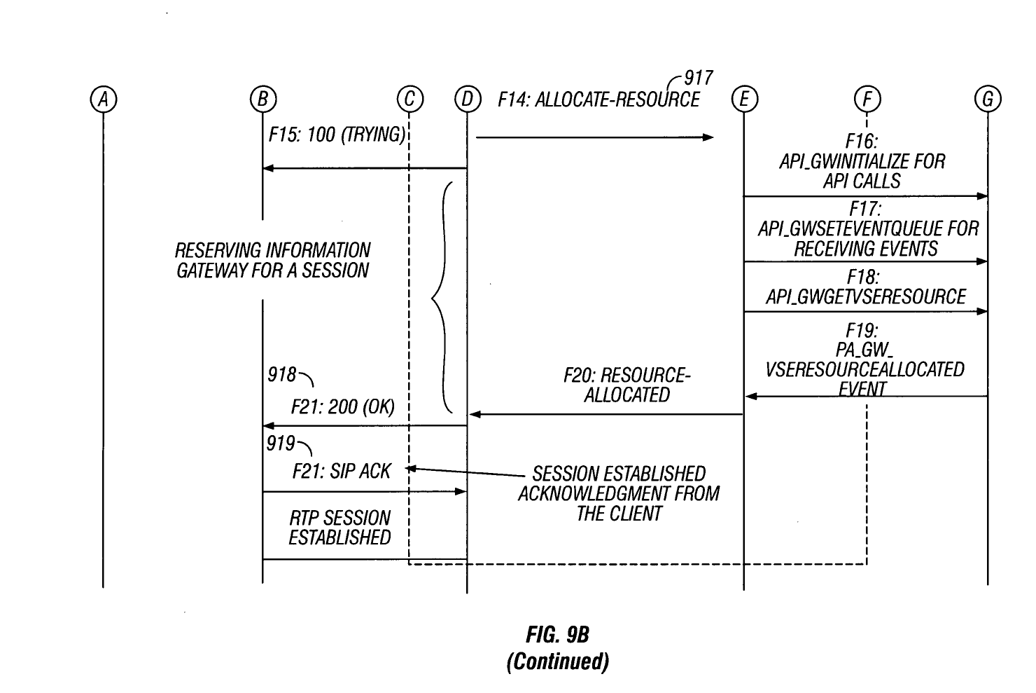

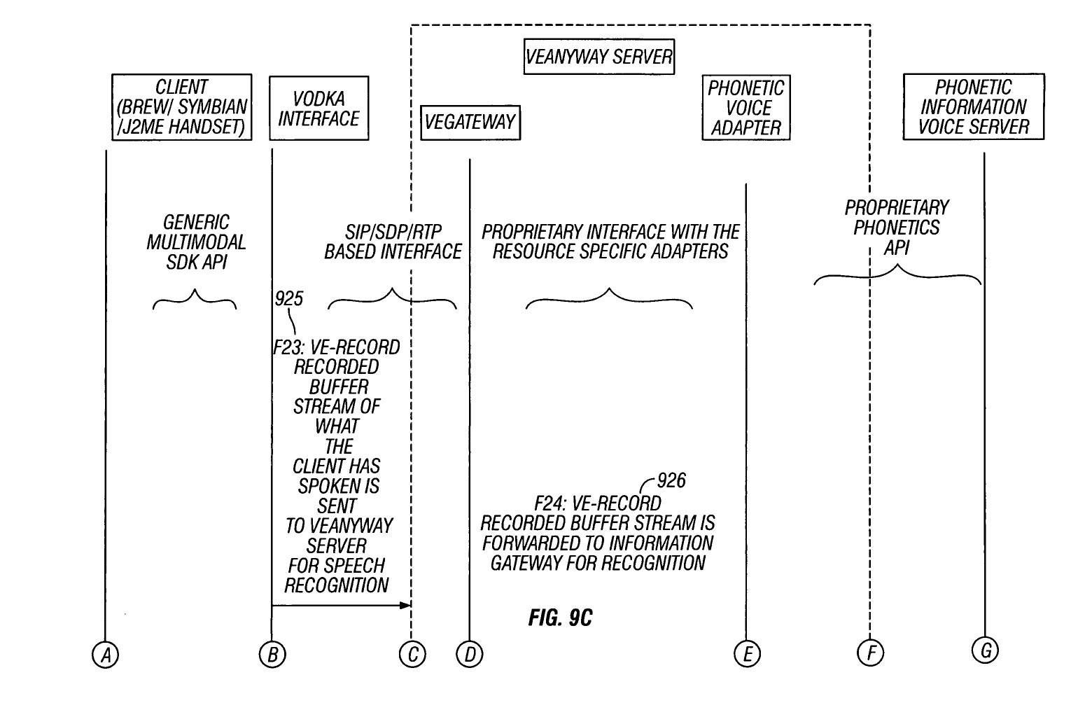

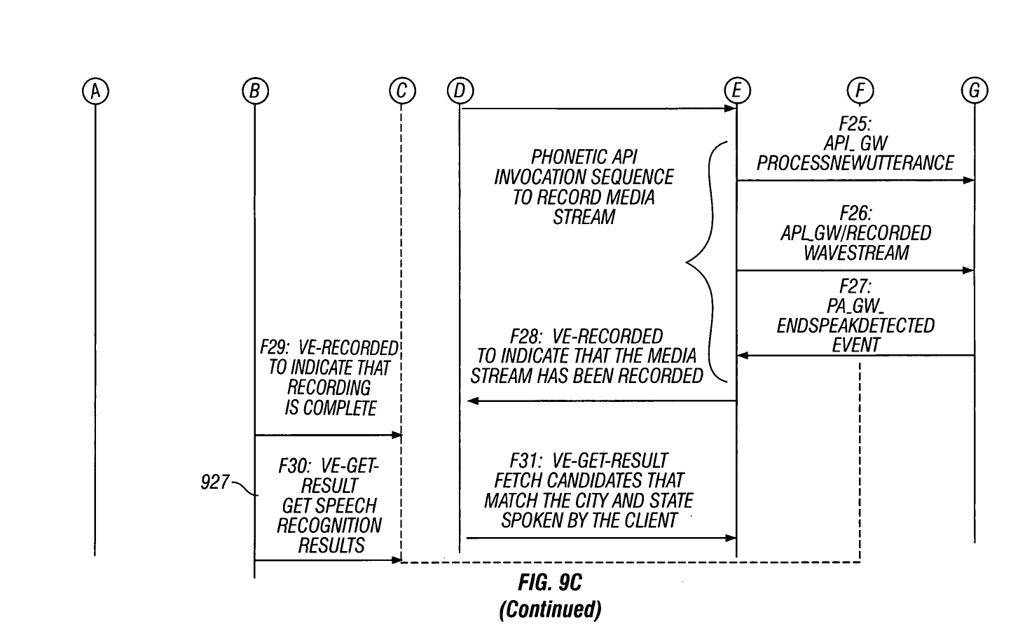

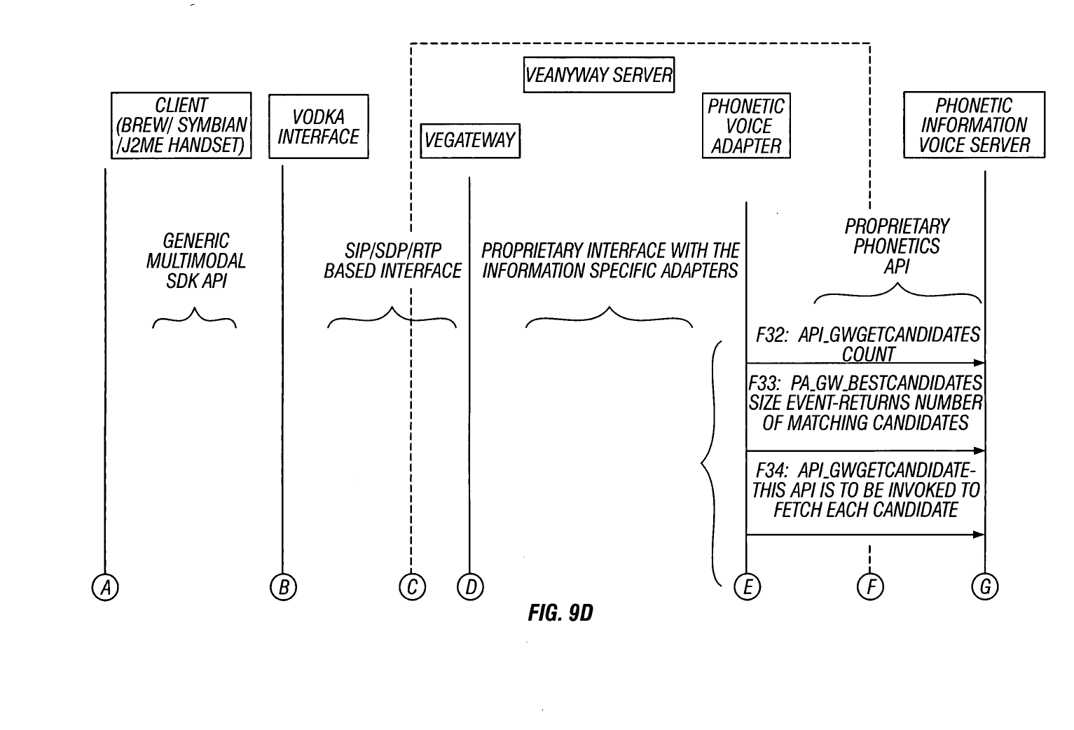

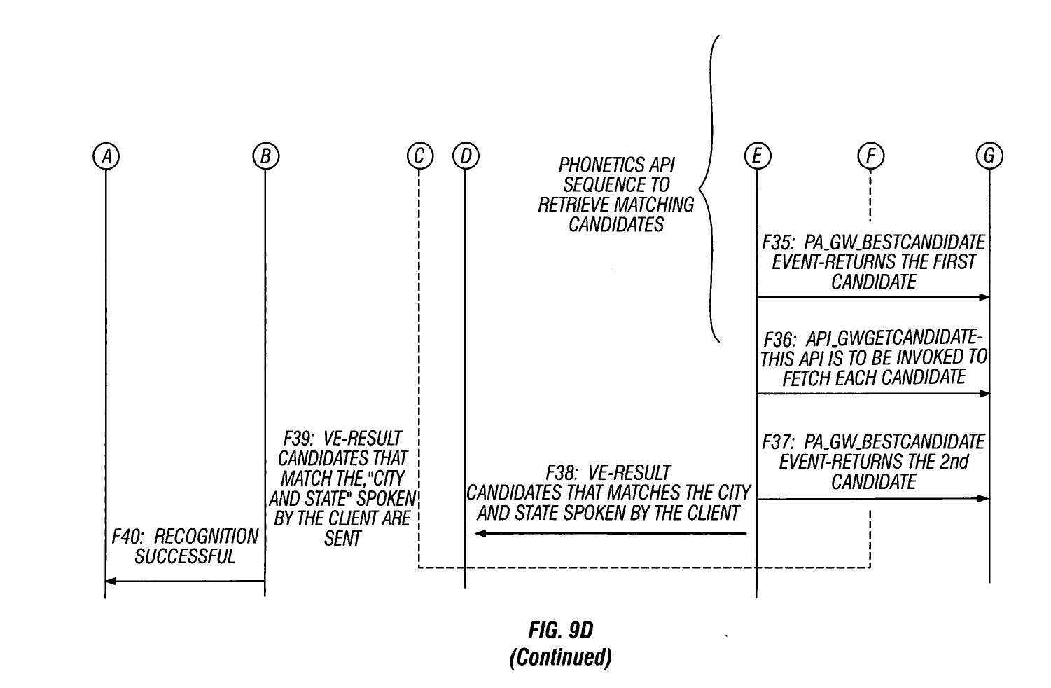

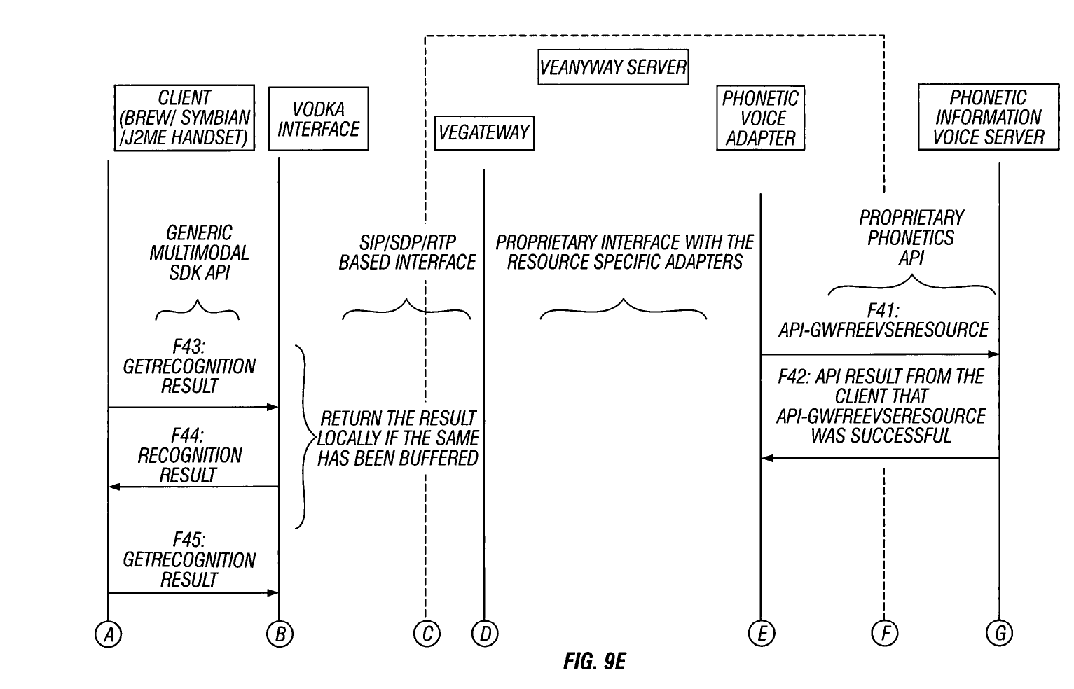

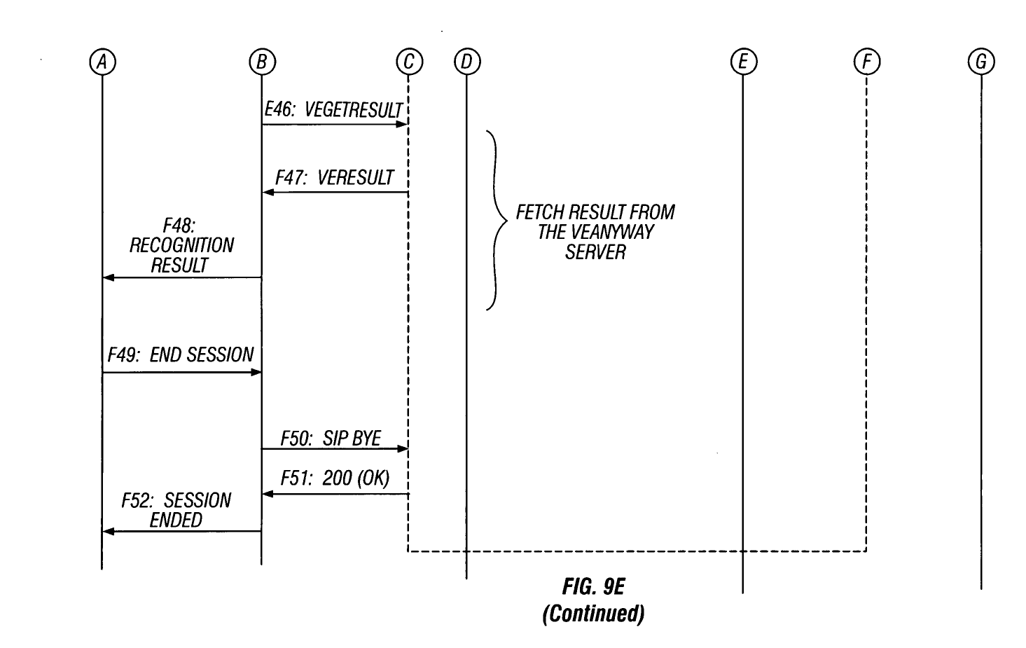

The process follows the flows shown in FIGS. 9A-9E. This shows the flow between the client 799 its Vodka Interface 802.

The server 804 which includes the Gateway portion 900 and the phonetic voice adapter 902, and the phonetic information voice server 905. The phonetic operations start with an initialization at 910 which sets up the TCP client for API calls, TCP events, and other events. At 912, the client establishes a TCP/IP channel, and registers on the SIP and RTP channels. This also includes basic user validation and also license validation.

In FIG. 9B, the basic operation has been started, and the system recognizes speech input at 914. The application captures the spoken word input, and uses the API to recognize speech and fetch corresponding listings from the client.

Internally, once the speech is recognized, the server initiates the session at 915 using the SIP invite at 916.

During session initiation it also specifies which information gateway is to be used for this session using SDP attribute “a=X-attribute_type:VOICE” in the INVITE message body. The veGATEWAY server sends ALLOCATE_RESOURCE event to the corresponding information adapter as specified in the INVITE message body to carry out information gateway specific initialization if any needs to be done at 917. The Information adapter is RESOURCE_ALLOCATED event after the initialization is complete.

Upon receiving this event, veGATEWAY server sends a SIP 200 OK response to the client at 918. The SDK acknowledges the session establishment procedure with the SIP ACK message at 919 to complete session establishment.

In FIG. 9C, the SDK sends a VE_RECORD event with the client spoken input at 925. The veGATEWAY server invokes the codec converter if any media conversion is required for a specific information gateway and forwards the recorded input to the voice information gateway. The client is notified that recording has been completed using VE_RECORDED event. The SDK now sends a VE_GET_RESULT event to fetch voice recognition results at 926. veGATEWAY server responds VE_RESULT event that has the total candidate count and a subset candidate lists (as was requested by the client). veGATEWAY server buffers the recognition results and releases the voice resource. The SDK also buffers a subset candidate list.

The application now invokes the GetRecognitionResult SDK api at 927 to display the matching candidate list to the client. If the requested number of candidates are available in the buffered candidate list available with the SDK, the same is immediately returned. Otherwise, the SDK sends VE_GET_RESULT to the veGATEWAY server to fetch the candidate list from the server as shown in FIG. 9d.

The user can then scroll the list to get the desired information.

Although only a few implementations have been described above, other modifications are possible. For example, while only a few kinds of languages have been described, other languages, and especially other flavors of XML can be used. All such modifications are intended to be encompassed within the following claims.

1. A method, comprising:
operating a portable communication device in a way that supports a number of different modes of communication, including at least a voice communication mode and a data communication mode, and where all of said modes accept input from the portable communication device to be sent in the mode, and provide output to the portable communication device, in the mode;
sending a request from the portable communication device to a database for specified information, said requests being sent in a first mode; and
returning an answer to the request in a second mode, different than the first mode.

2. A method as in claim 1, wherein said first mode is a voice mode, and said second mode is a text mode.

3. A method as in claim 1, wherein said modes include a data mode, a text mode, a multimedia mode, and a voice mode.

4. A method as in claim 2, wherein said request is a request for information.

5. A method as in claim 4, wherein said output is provided as a list with a number of different possibilities, and an interface that enables selecting an output of said list.

6. A method as in claim 1, wherein said sending comprises sending a request to a server which includes at least one command as an XML tag.

7. A method as in claim 6, wherein said XML tag is a switch command that commands switching from one mode to another mode.

8. A method as in claim 7, wherein said switch command includes information indicative of a URL associated with the mode switching.

9. A method as in claim 6, wherein said XML tag is one that requests that the message of a specified type be sent to the portable communication device.

10. A method as in claim 6, wherein said XML tag requests that an SMS message be sent to the portable communication device.

11. A method as in claim 1, wherein said operating comprises operating sessions in the first and second mode simultaneously.

12. A method as in claim 1, wherein said operating comprises initiating a session using a session initiation protocol, and operating the session using a real-time transport protocol.

13. A portable communication device, comprising:
a communication part which allows communicating in at least first and second modes, wherein at least one of the modes is a voice based mode that communicates between the communication part and the server, and a second of the modes is a text based mode which communicates text between the portable communication device and the server;
a request sending part, which uses the communication part to send a request to a server, based on an initiation in a first mode and which includes a command within the request requesting that an answer to the request be sent in a second mode different than the first mode.

14. A device as in claim 13, wherein the second mode is a text based mode.

15. A device as in claim 14, wherein the second mode comprises sending an SMS to the portable communication device.

16. A system comprising:
a communication gateway, that receives messages and information from at least one cellular telephone, and which allows multiple modes to operate simultaneously on the same session with the same phone.

17. A method, comprising:
using a portable telephone to request information;
receiving a response to the request as a text based response including text based response to the information, and a telephone number; and
automatically dialing the telephone number to hear a voice based response to said request.

18. A method as in claim 17, wherein said response is an SMS email.

19. A method as in claim 17, wherein said request is via a voice request.

20. A method, comprising
communicating from a client in a portable telephone to a gateway by first using a session initiation protocol to establish a session, and once establishing the session, using a real-time transfer protocol to establish a real-time transfer link to an information server, said real-time transfer protocol including commands which request specified types of information, and receive said information in real-time responsive to said commands.

21. A method as in claim 20, wherein said session initiation protocol operates to reserve resources on the gateway to enable the real-time transfer protocol to conduct its session.

22. A method as in claim 21, wherein one of said gateways is a voice information gateway, and the real-time transfer protocol transfers recorded speech to the voice information gateway for recognition by the gateway.

23. A method as in claim 20, further comprising communicating between said client and said server using real-time transfer protocol messages and said reservation initiation protocol messages.

24. A method as in claim 222, further comprising recognizing that spoken speech has been entered, and automatically sending a session initiation protocol message to recognize the entered speech.

25. A method as in claim 20, wherein said real-time transfer protocol includes specific messages for interacting with a voice server, a data server, and a text server.

26. A method as in claim 20, wherein said communicating comprises establishing a session using said session initiation protocol, and reserving resources on information server responsive to said initiating the session.
